(19) United States
(12) Patent Application Publication
(10) Pub. No.: US 2007/0235107 A1
(43) Pub. Date: Oct. 11, 2007

(54) WOODWORKING APPARATUS AND METHOD

(76) Inventor: Philip Winskunas, Sioux Falls, SD (US)

Correspondence Address: SCHWEGMAN, LUNDBERG & WOESSNER, P.A., P.O. BOX 2938, MINNEAPOLIS, MN, 55402, US

(21) Appl. No.: 11/692,107

(22) Filed: Mar. 27, 2007

Related U.S. Application Data
(60) Provisional application No. 60/743,862, filed on Mar. 28, 2006.

(51) Int. Cl. B25H 1/00

(52) U.S. Cl. 144/286.1; 144/286.5; 144/287

(57) ABSTRACT

A table top and a worktable are combined to form a workbench adapted to receive a plurality of work tools. Various tools can be quickly connected and disconnected. This facilitates changing of tools on the workbench.

### RELATED APPLICATION

This application claims the benefit under 35 U.S.C. 119(e) of U.S. Provisional Application Ser. No. 60/743,862 filed Mar. 28, 2006, which application is incorporated by reference and made a part hereof.

### BACKGROUND

Woodworking is a common avocation for many. Woodworking can require many tools to produce a quality product. Like many avocations, it seems a woodworker can always find another woodworking tool or machine that would be nice to have. Thus, a woodworking enthusiast can collect many tools to practice his or her craft. For example, some woodworkers have tools and machines such as radial arm saws, table saws, belt sanders, other sanders, planers, routers, drill presses, engine lathes, a variety of work tables, and an assortment of clamps and fasteners, and the like. The lucky woodworking enthusiast has sufficient room to have many or most of these tools mounted on tables so that most of the tools or many of the tools are “ready to go”. Woodworking generally requires the use of several of these tools to produce a quality product. Upon finishing a task at one station, the woodworking enthusiast moves to the next station to perform another operation on the project. The lucky woodworking enthusiast may have an entire outbuilding, garage or basement devoted to housing the tools of their avocation. Many woodworkers simply are not lucky enough to have this amount of room. As a result, many times they have to put away one tool and get another tool out between operations on a project. This can be time consuming and may lessen the enjoyment associated with the avocation.

### BRIEF DESCRIPTION OF THE DRAWINGS

FIG. 1A is a perspective view of a workbench combined with a multiple use table top, according to an example embodiment.

FIG. 1B is an exploded front view of a workbench combined with a multiple use table top, according to an example embodiment.

FIG. 2 is a perspective view of a workbench, according to an example embodiment.

FIG. 3 is a top view of the multiple use table top, according to an example embodiment.

FIG. 4 is a bottom side perspective view of a mount rail attached to the table top, according to an example embodiment.

FIG. 5A is a side view of mount rail of the table top engaged with a workbench, according to an example embodiment

FIG. 5B is a side view a table top for a workbench, according to an example embodiment.

FIG. 6 is a perspective view of a workbench combined with a multiple use table top having a router table mounted thereon, according to an example embodiment.

FIG. 7 is a perspective view of a workbench combined with a multiple use table top having a mitre box mounted thereon, according to an example embodiment.

FIG. 8 is a method for using a workbench combined with a multiple use table top, according to an example embodiment.

FIG. 9 is a perspective view of a kit including a multiple use table top, fasteners and a set of instructions, according to an example embodiment.

FIG. 10 is a side view of a mounting method for a tool having a flat base, according to an example embodiment.

FIG. 11 is a side view of a mounting method for a tool having a leg base, according to an example embodiment.

FIG. 12 is a top view of a table top that includes multi-use surface, according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description is, therefore, not to be taken in a limited sense, and the scope of the present invention is defined by the appended claims.

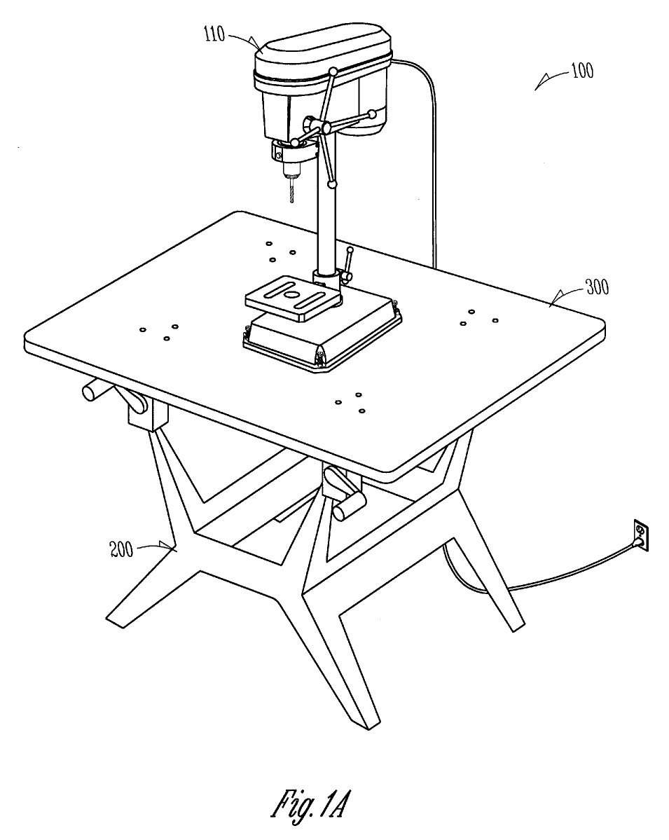

FIG. 1A is a perspective view of a worktable or a multiple-use worktable 100, according to an example embodiment. FIG. 1B is an exploded front view of a workbench combined with a multiple use table top, according to an example embodiment. Now referring to both FIGS. 1A and 1B, the multiple-use worktable 100 is comprised of a workbench 200, and a table top 300. The workbench 200 holds the table top 300 in one of a number of positions. The workbench 200 holds the table top 300 substantially rigidly with respect to the workbench. Mounted to the table top 300 is a tool 110. As shown in FIG. 1, the tool 10 mounted to the table top 300 is a drill press. The tool 110 is mounted using fasteners as shown. In one embodiment, the tool 110 is mounted using quick connect type fasteners.

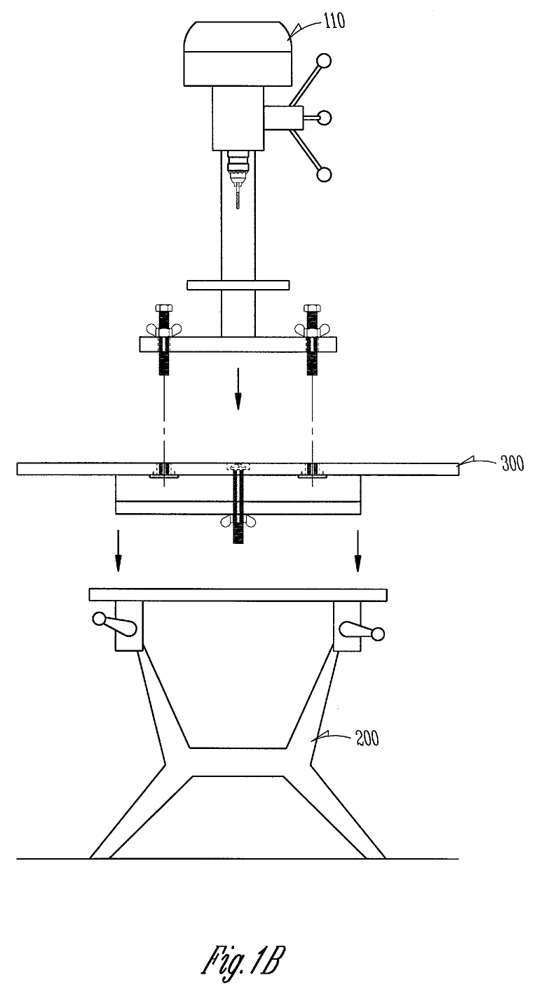

FIG. 2 is a perspective view of a workbench 200, according to an example embodiment. The workbench 200 includes a frame 210 and a first slat 230 and a second slat 232. The workbench 200 also includes a clamp 240 and a clamp 242. At least one of the clamps 240, 242 is used to move the slat 230 with respect to the slat 232 or vice versa. Movement of one slat 230 with respect to the other slat 232 is accomplished by turning or rotating the handles of the clamp 240 or clamp 242, respectively. With one or more of the clamps 240, 242 the slats 230 and 232 can be positioned to hold various items. Such a workbench 200 is available from one of several manufacturers. For example, the workbench 200 is available as a Work Mate from Black & Decker Corporation of Towson, Md. The workbench 200 also includes a base ledge 220. The base ledge adds further rigidity to the workbench 200.

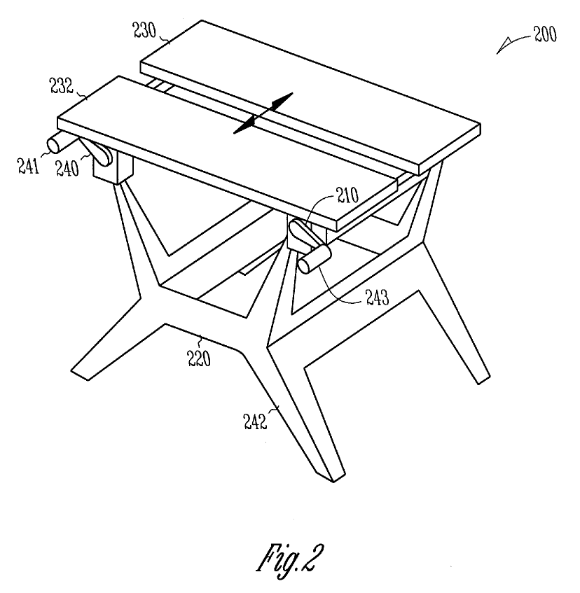

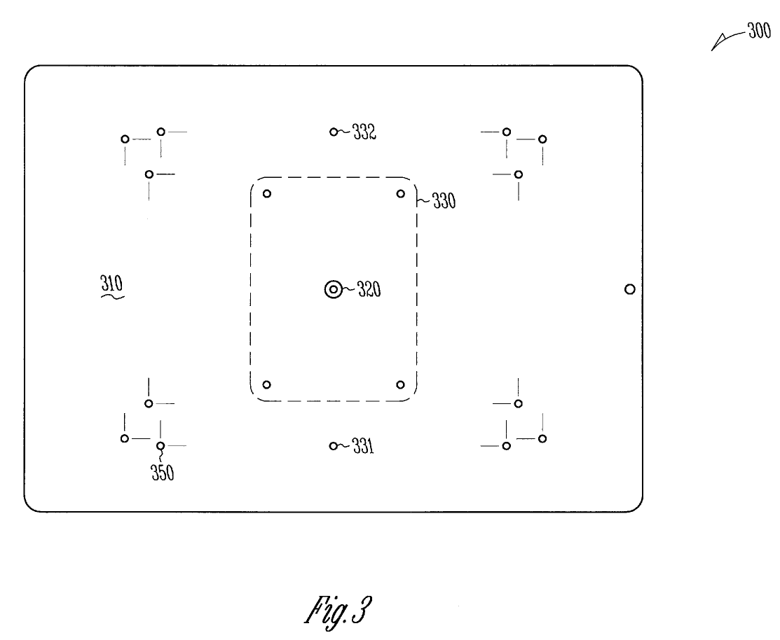

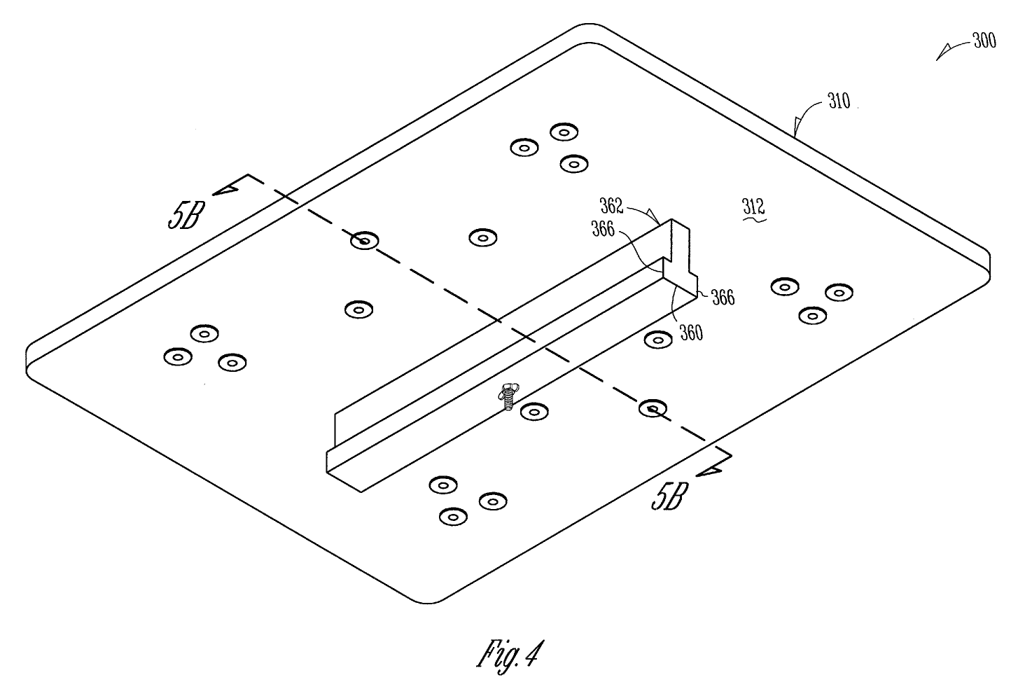

FIG. 3 is a top view of a multiple use table top 300, according to an example embodiment. FIG. 4 is a bottom side perspective view of the multiple use table top 300, according to an example embodiment. Now referring to both FIGS. 3 and 4, the multiple use table top 300 will be further detailed. The multiple use table top 300 includes a top surface 310 and a bottom surface 312. The table top includes a threaded opening or opening 320 which receives a fastener 362. The table top also includes a rail 360 which is attached to the bottom surface 312 of the multiple use table top 300. A rail 360 is attached to the table top 300 by a fastener 362. A single fastener 362 is used to fasten the rail 360 to the table top 300 so that the rail or rail 360 or the table top 300 can rotate with respect to the other of the rail or table top. This allows the table top 300 to be placed in any position with respect to the rail 360. The fastener 362 is loosened while the user adjusts the position of the rail 360 with respect to the table top 300. Once positioned as desired, the user tightens the fastener 362 to fix the position of the rail 360 with respect to the multiple use table top 300. In one embodiment of the invention, the fastener 360 includes a threaded end which is received into a threaded portion of the opening 320. In another embodiment (as shown in FIG. 5) the fastener extends through the opening 320 and a nut engages the fastener 362. The top surface 310 of the table top 300 includes a template 330 for a tool or woodworking tool, such as the tool 110 shown in FIG. 1. The template 330 is an outline of the base of a particular tool. Associated with the outline are mounting openings, such as mounting opening 331 and 332 which receive a fastener for securely attaching a tool to the table top 300. The table top 300 typically includes multiple templates or outlines. For example, in FIG. 3 another template 350 is shown which is an outline for holding another tool. In one embodiment of the invention, the table top 300 is provided with a marker that a user may use to make additional templates on the top surface 310 of the table top 300. In other embodiments of the invention, the table top 300 may include markings for several popular tools that could be mounted to the table top 300. For example, a manufacturer may have a very popular tool or set of tools that could be mounted to the table top 300. The manufacturer can provide templates for several popular tools to which a user can mount to a table top. This eases the use of the table top 300 for a user such as a woodworking enthusiast. In such an arrangement, a marker may still be provided to the user so that the user could provide or make other templates for other tools that he or she might already have. Many times a user will want to customize the mounting or move the mounting to one side or another to fit their personal preferences. As shown in FIG. 4, the rail 360 also includes a first rail wing 364 and a second rail wing 366. The rail wings 364, 366 act as stops to prevent the rail 360 from accidentally becoming disengaged from the slats 230, 232 of the work bench 200 (see FIG. 2).

FIG. 5A is a side view of the mount rail 360 attached to the table top 300, according to an example embodiment. FIG. 5B is a side view of the mount rail 360 attached to the table top 300, according to another example embodiment. Now looking at FIG. 5A actually details how the slats 230 and 232 engage the rail 360. The clamps are removed for the sake of simplicity. The rail 360 is compressed between the first slat 230 and the second slat 232. The clamp 240, 242 (shown in FIG. 2) provides the compression force or clamping force. Therefore the clamp 240, 242 places a force on the edge of the slats 230, 232 to pinch or hold the rail 360. In most instances, the clamping force between the first slat 230 and the second slat 232 will hold the rail 360 in position with respect to the workbench 200. The rail 360 includes a rail wing 364 and a rail wing 366. The rail wing 364 and the rail wing 366 prevent upward vertical movement of the rail 360 with respect to the slats 230, 232. Thus, even if a tool attached to the top surface 310 of the table top 300 were to vibrate or otherwise produce a force that would tend to remove the rail 360 with respect to the slats 230, 232, the rail wing 364 and the rail wing 366 would limit or stop upward vertical movement and maintain engagement of the slats 230, 232 with the rail 360.

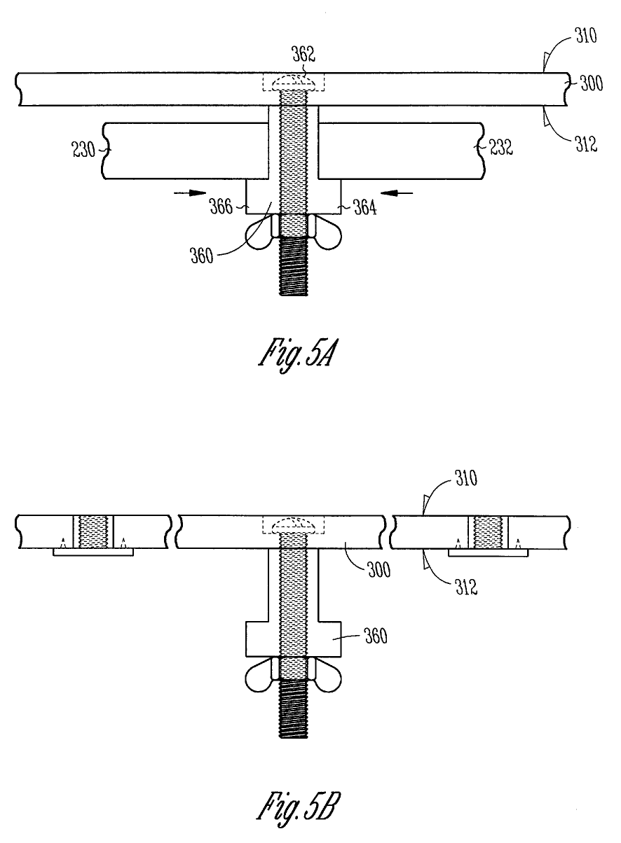

Once the rail 360 and the table top 300 are engaged with the slats 230, 232 of the workbench 230, the multi-purpose work table 100 is formed. Various tools can be attached to the work table. For example, FIG. 6 is a perspective view of a multi-purpose work table 100 having a router table 600 attached to the upper surface 310 of the table top 300.

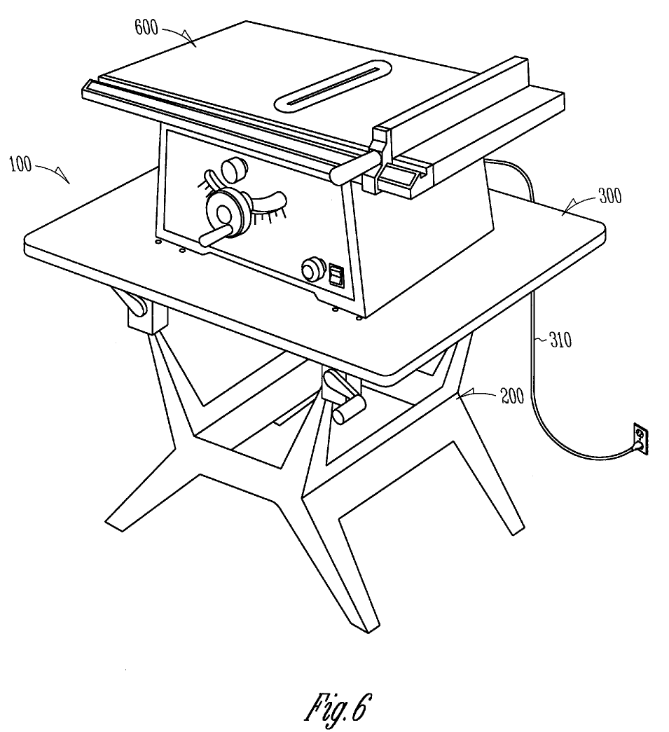

FIG. 7 is a perspective view of a workbench 200 combines with a multiple use table top 300 having another tool mounted thereon, according to another example embodiment. In this particular example embodiment, a miter box 700 is attached to the top surface 310 of the table top 300.

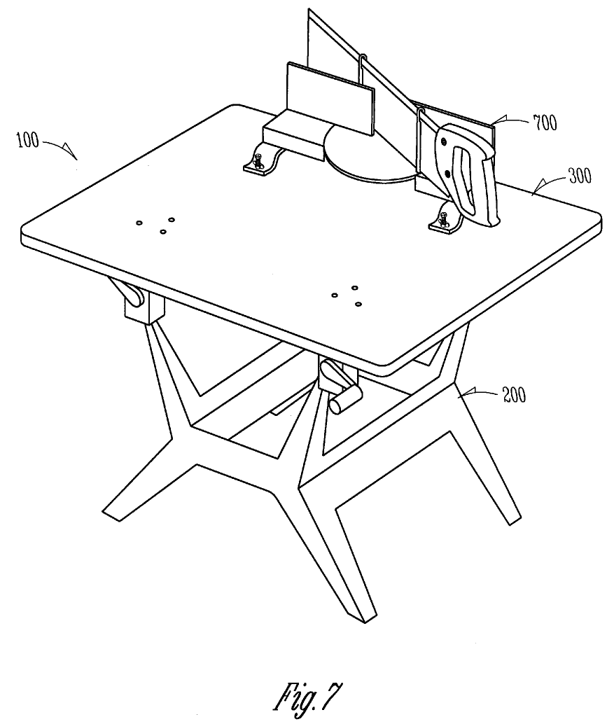

FIG. 8 is a method 800 for using a workbench 200 combines with a multiple use table top 300, according to an example embodiment. The rail is initially fixed with respect to the table top, as depicted by reference numeral 810, and then the table top is placed onto the workbench so that the rail is positioned between the slats of the workbench, as depicted by reference numeral 812. The slats are then used to clamp the rail of the table top, as depicted by reference numeral 814. The tool is placed onto the work bench and placed in a desired position. A template is then formed around the base of the tool on the top surface of the table top, as depicted by reference numeral 816. The tool is fastened to the table top, as depicted by reference numeral 818. The various elements of the method 800 for using the workbench and table top do not have to be done in the same order as listed above. For example, a user can mount a tool to the table top 818 and then make the template or mark the top surface of the table top 816. Mounting the tool to the table top 818 can be done in any number of ways. In one example embodiment of the invention, holes are drilled in the table top 300 that corresponds to the mounting holes of a particular tool. A threaded fastener, such as a T-nut, is then placed into the opening on the bottom or backside surface 312 of the table top 300. The threaded fasteners remain in the table top 300 for use at a later time. Quick connectors are then used to mount a tool, such as tool 110 (shown in FIG. 1) to the table top. After initially mounting the tool to the countertop 818 and mounting the tool to the countertop 816 are initially accomplished, the tool can be quickly mounted and taken off of the table top 300 so that the user can quickly change tools by merely removing the tool that the user is finished with, placing a tool within the template, such as template 350, and then fastening the tool to the table top 300. Thus, the user can quickly interchange between tools so that various operations can be accomplished on a work piece. The workbench 200 and table top 300 can be left in their engaged position forming the worktable 100 so that different tools may be quickly mounted to the table top. The user can also disassemble the table top 300 from the workbench 200 for purposes of storage.

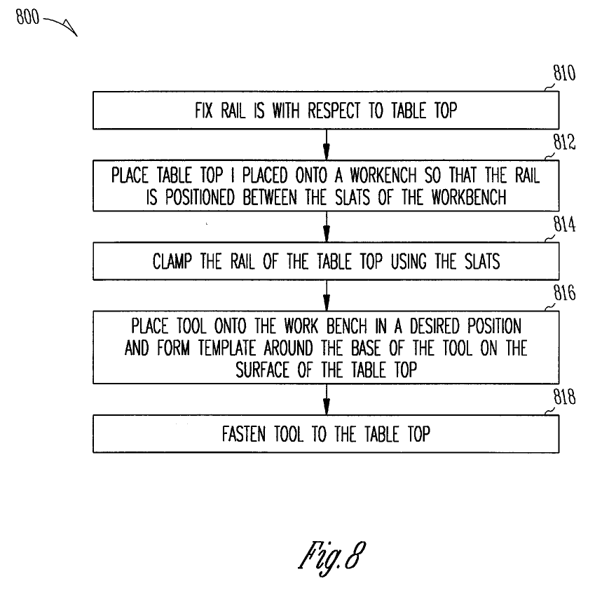

FIG. 9 is a perspective view of a kit 900 including a multiple use table top 300, fasteners 910, 912, 914 and 916, and a set of instructions 930, according to an example embodiment. The kit 900 can also include a marker 940 for forming templates or forming custom templates on the top surface 310 of the table top 300. Instructions 930 can be in the form of a printed book, a floppy disk, a CD rom or a DVD, or an instructional video, or the like. Instructions would detail the method or methods of use of the table top 300 with respect to a workbench 200. The instructions would also show the making of a template and mounting a tool on to the table top 300. Of course, the kit 900 can include additional fasteners than those shown. Some embodiments of the kit 900 may include a workbench 200 (shown in FIGS. 1 and 2). In one embodiment of the kit 900 may be considered as an add on or optional feature associated with a workbench 200. In yet embodiment of the kit 900, everything is included to form a work table 100, as shown in FIG. 1. In still other example embodiments, a particular tool may also be included as part of the kit 900.

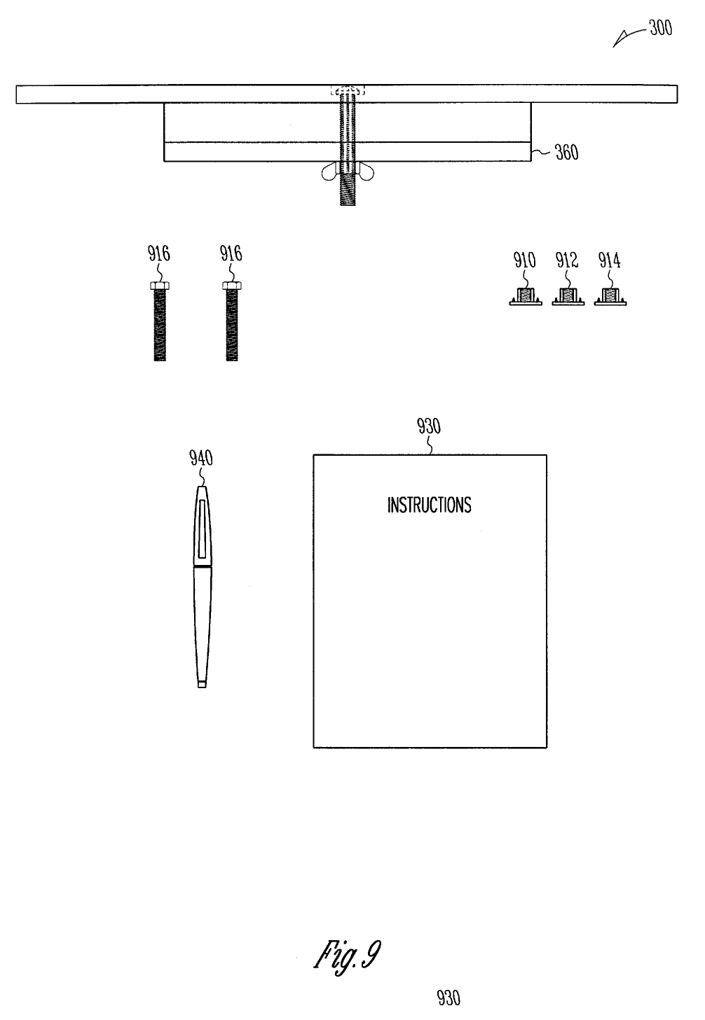

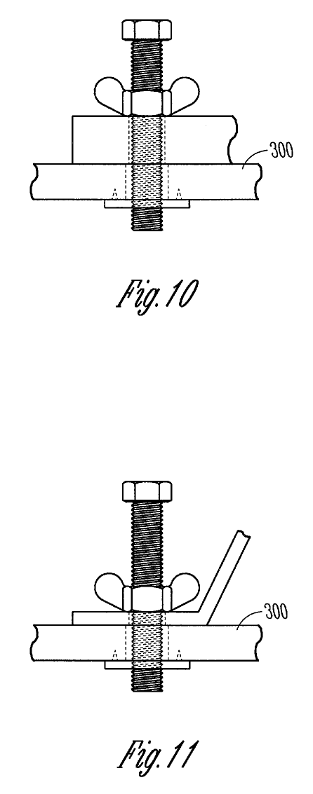

FIGS. 10 and 11 show mounting methods for tools having different types of bases. FIG. 10 is a side view of a mounting method for a tool having a flat base, according to an example embodiment. FIG. 11 is a side view of a mounting method for a tool having a leg base, according to an example embodiment.

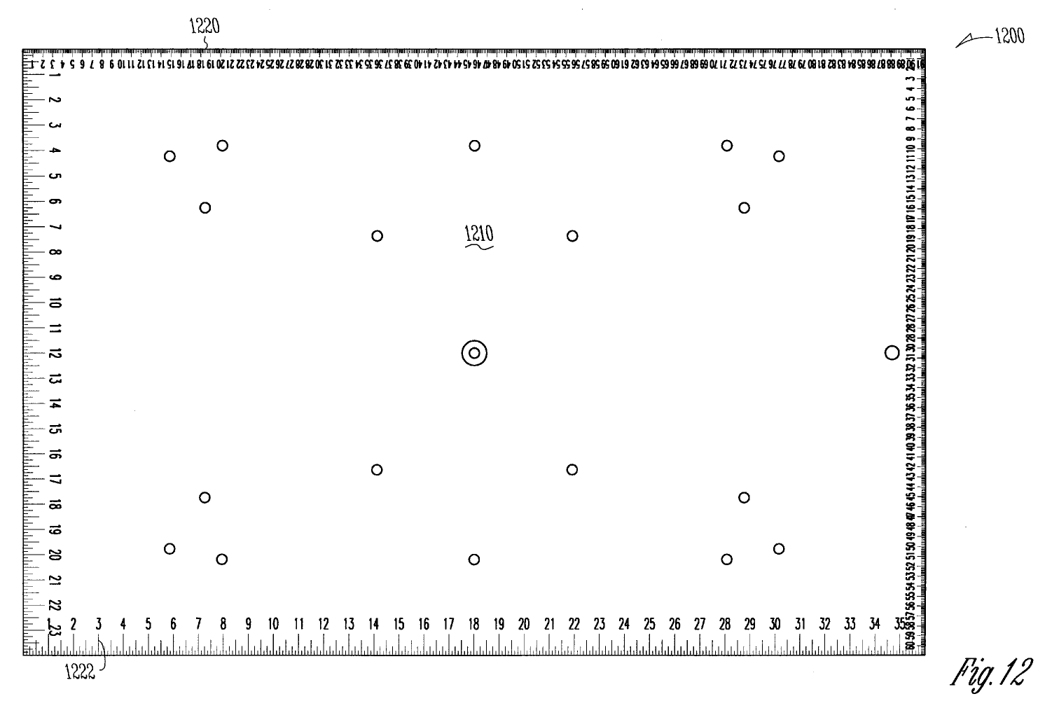

FIG. 12 is a top view of a table top 1200 that includes multi-use surface, according to another example embodiment. The table top 1200 includes a rail (not shown) similar to the table top discussed above. The rail is mounted so that it rotates with respect to the table top 1200 and yet can be secured so that the rail maintains a particular angle with respect to the table top 1200. The table top 1200 can then be clamped to the work table by way of the clamp, the first slat and the second slat. The first slat and the second slat capture and clamp to the rail (not shown). The surface of the table top 1200 includes a grid system 1210 with a series of orthogonal lines. The table top 1200 also includes a ruler 1220 or set of rulers 1220, 1222 that include english units of measure as well as metric units of measure. In some embodiments, both rulers may be on a single table top 1200. In other embodiments either the ruler in the english units or the ruler using metric units is used. The grid system 1210 provides for easy lay out of projects, such as sewing projects, quilting projects or projects that require measurement. The grid system 1210 allows for ease of cutting and measuring such projects, for example.

The Abstract is provided to comply with 37 C.F.R. § 1.72(b) to allow the reader to quickly ascertain the nature and gist of the technical disclosure. The Abstract is submitted with the understanding that it will not be used to interpret or limit the scope or meaning of the claims.

1. (canceled)

1. A table top adapted to receive a plurality of work tools comprising:
a first surface that further includes a template for a work tool, the table top also including openings therein corresponding to openings in a work tool;
a second surface; and
a rail attached to the table top at the second surface.

2. The table top of claim 1 wherein the rail is attached to allow rotation of the rail with respect to the second surface.

3. The table top of claim 1 wherein the rail is attached so that the rail can be substantially fixed at a particular angle with respect to the second surface of the table top.

4. The table top of claim 1 wherein the template includes an outline of a work tool.

5. The table top of claim 1 wherein the outline encompasses openings in the tabletop associated with the work tool.

6. The table top of claim 1 wherein the first surface includes a plurality of templates for a plurality of tools.

7. The table top of claim 6 wherein the first surface includes features for distinguishing at least one of the plurality of templates from the other of the plurality of templates.

8. The table top of claim 1 wherein the rail is dimensioned to be clamped by a work table.

9. The table tope of claim 8 wherein the rail includes features that engage at least one feature of a clamp on a work table.

10. A system comprising:
a table top adapted to receive a plurality of work tools, the table top further comprising:
a first surface that further includes a template for a work tool, the table top also including openings therein corresponding to openings in a work tool;
a second surface; and
a rail attached to the table top at the second surface; and
a work table that further includes:
a first slat;
a second slat; and
a clamp attached to the first slat and the second slat, the clamp producing a clamping force between the first slat and the second slat, the first slat and second slat clamping rail to the work table.

11. The system of claim 10 wherein the rail is attached to allow rotation of the rail with respect to the second surface of the table top.

12. The system of claim 10 wherein the rail is attached so that the rail can be substantially fixed at a particular angle with respect to the second surface of the table top.

13. The system of claim 10 wherein the template on the table top includes an outline of a work tool.

14. The system of claim 10 wherein the first surface of the table top includes a plurality of templates for a plurality of tools.

15. The system of claim 10 further comprising a set of instructions for using the system.

16. A method for using a workbench having movable slats, the method comprising:
affixing a rail with respect to a table top;
placing the table top onto the workbench so that the rail is positioned between the slats of the workbench;
clamping the rail of the table top between the slats; and
forming a template around the base of the tool on the top surface of the table top.

17. The method of claim 16 further comprising placing a tool onto the work bench and placed in a desired position.

18. The method of claim 16 further comprising forming another template around the base of another tool on the top surface of the table top.

19. The method of claim 16 further comprising fastening the tool to the table top.

20. The method of claim 19 further comprising:
drilling a plurality of holes in the table top corresponding to a plurality of mounting holes in the tool; and
passing a plurality of fasteners through the plurality of openings in the table top and corresponding mounting holes in the tool.
